(19) United States
(12) Patent Application Publication
(10) Pub. No.: US 2010/0078050 A1
(43) Pub. Date: Apr. 1, 2010

(54) High-pressure cleaning device

(75) Inventors: Lutz Bauer, Victoria (AU); Harald Schestag, Sulzbach (DE)

Correspondence Address: Lipsitz & McAllister, LLC, 755 MAIN STREET, MONROE, CT, 06468, US

(73) Assignee: Alfred Kaercher GmbH & Co. KG, Winnenden (DE)

(21) Appl. No.: 12/587,014

(22) Filed: Sep. 29, 2009

Related U.S. Application Data
(63) Continuation of application No. PCT/EP2008/002817, filed on Apr. 10, 2008.

(30) Foreign Application Priority Data
Apr. 12, 2007 (DE) 10 2007 018 250.5

(51) Int. Cl. B08B 3/00

(52) U.S. Cl. 134/198

(57) ABSTRACT

The invention relates to a high-pressure cleaning device having a housing in which a pump and a drive motor are disposed, it being possible for pressurized liquid to be delivered by the pump via a high-pressure hose and it being possible for the high-pressure hose to be wound onto a hose drum which is mounted within the housing such that it can rotate about a rotation axis, and for said high-pressure hose to be routed out of the housing at the rear. In order to develop the high-pressure cleaning device in such a way that it has a shorter structure, the invention proposes aligning the rotation axis of the hose drum parallel to the horizontal axis of the housing.

This application is a continuation of international application number PCT/EP2008/002817 filed on Apr. 10, 2008.

The present disclosure relates to the subject matter disclosed in international application number PCT/EP2008/002817 of Apr. 10, 2008 and German application number 10 2007 018 250.5 of Apr. 12, 2007 which are incorporated herein by reference in their entirety and for all purposes.

### BACKGROUND OF THE INVENTION

The invention relates to a high-pressure cleaning device having a housing in which a pump and a drive motor are disposed, it being possible for pressurized liquid to be delivered by the pump via a high-pressure hose and it being possible for the high-pressure hose to be wound onto a hose drum which is mounted within the housing such that it can rotate about a rotation axis, and for said high-pressure hose to be routed out of the housing at the rear.

Utility model DE 299 14 193 U1 discloses a high-pressure cleaning device in which the hose drum onto which the high-pressure hose can be wound is disposed on the outside at an end face of the housing. The high-pressure hose can be unwound from the hose drum on a longitudinal face of the housing via a hose guide device. The hose drum is freely accessible. Therefore, there is a risk of the hose drum, in particular the bearing of said hose drum, being damaged during use of the high-pressure cleaning device. In addition, the high-pressure cleaning device cannot be placed directly alongside a wall since it is necessary to leave enough space to the side of the high-pressure cleaning device to unwind the high-pressure hose from the hose drum.

Laid-open specification EP 0 770 575 A1 discloses a high-pressure cleaning device in which the hose drum is disposed within the housing and the high-pressure hose is routed out of the housing via a rear opening. The high-pressure hose can be wound up by means of a hand crank which is mounted on the side of the housing. The rotation axis of the hose drum is oriented parallel or perpendicular to the vertical axis of the housing. During operation of the high-pressure cleaning device, the housing assumes a vertical position and, in order to be moved, it can be tilted in the manner of a sack truck, said housing having a relatively long extent and therefore having to be moved carefully.

It is an object of the present invention to develop a high-pressure cleaning device of the type mentioned in the introduction in such a way that it has a shorter structure.

### SUMMARY OF THE INVENTION

According to the invention, this object is achieved in a high-pressure cleaning device of the generic type in that the rotation axis of the hose drum is aligned parallel to the horizontal axis of the housing.

In the case of the high-pressure cleaning device according to the invention, the hose drum is disposed within the housing and is therefore protected against damage. There is virtually no risk of the hose drum, in particular the bearing of said hose drum, being damaged during operation of the high-pressure cleaning device. The high-pressure hose can be unwound from the hose drum at the rear face of the high-pressure cleaning device. To this end, the high-pressure hose is routed out of the housing at the rear. This simplifies handling of the high-pressure cleaning device, in particular, no space is required alongside the high-pressure cleaning device in order to be able to wind up and unwind the high-pressure hose.

The rotation axis of the hose drum is aligned parallel to the horizontal axis of the housing. This allows a particularly short construction of the housing, and therefore the high-pressure cleaning device according to the invention is distinguished by a compact design.

The hose drum can be rotated in order to wind up the high-pressure hose. In a preferred configuration of the invention, a hand crank is rotatably mounted on the rear face of the housing for this purpose. It is advantageous when the rotation axis of the hand crank is aligned coaxially with the rotation axis of the hose drum, in particular, provision may be made for the hand crank to be connected to the hose drum in a rotationally fixed manner.

A configuration of the high-pressure cleaning device according to the invention in which it is of particularly short construction is distinguished in that the hand crank is disposed in a recess in the rear face of the housing. This has the advantage that the hand crank protrudes at the most slightly beyond the rear face of the housing since it is, for the most part, accommodated by the recess in the rear face of the housing.

In a preferred configuration, operator control elements of the high-pressure cleaning device are disposed above the recess. For example, a switch for switching on and switching off the drive motor which drives the pump can be disposed above the recess. Indicator elements can also be disposed above the recess, for example a temperature indicator if the high-pressure cleaning device can be heated. The arrangement of operator control elements above the recess which accommodates the hand crank on the rear face of the housing simplifies handling of the high-pressure cleaning device since the operator can operate the high-pressure cleaning device while standing at the rear face.

It is advantageous when at least one filling opening for filling a storage tank which is disposed in the housing is located in the recess. The housing may have, for example, a storage tank for a cleaning chemical which can be admixed with the pressurized liquid, preferably water. The storage tank can be filled via a filling opening which is disposed in the recess. This simplifies handling of the high-pressure cleaning device.

Provision may also be made for at least one filling opening for filling a storage tank which is disposed in the housing to be disposed next to the recess, for example, the housing may have a storage tank for a limescale-removing solution, which storage tank can be filled via a filling opening which is disposed laterally next to the recess.

It is particularly advantageous when the recess is disposed between two filling openings, it being possible for in each case a storage tank to be filled via said filling openings. For example, two filling openings for storage tanks may be disposed on the rear face of the housing, preferably in each case in a corner region, with the recess being positioned between the two filling openings.

The high-pressure cleaning device may be designed such that it can be heated by it being possible for the pressurized liquid to be heated by means of a heat exchanger. Fuel which can be stored in a storage tank within the housing can be used to operate the heat exchanger. As already explained, a further storage tank can accommodate a limescale-removing solution, it also being possible for this storage tank to be filled via a filling opening which is disposed on the rear face of the housing, namely laterally next to the recess.

In a particularly preferred embodiment, all the operator control elements of the high-pressure cleaning device are disposed on the rear face of the housing. This allows particularly simple handling of the high-pressure cleaning device.

It is advantageous when a hose guide device is disposed in the housing for guiding the high-pressure hose from the hose drum to an opening in the rear face of the housing. The high-pressure hose can be guided within the housing by means of the hose guide device. This ensures that the high-pressure hose can be easily pulled out of the housing at the rear face of said housing and guided back into the housing as required. Unintentional formation of loops when winding up or unwinding the high-pressure hose or else trapping of the high-pressure hose can be avoided as a result.

In an advantageous configuration, the hose guide device comprises a plurality of deflection elements which are disposed at a spacing from one another. It has been found that the high-pressure hose can be wound up and unwound in a simple manner by a set of deflection elements which are spaced apart from one another. The high-pressure hose can be relieved of tension between mutually adjacent deflection elements, this making it easier to wind up and unwind said high-pressure hose.

It is advantageous when at least one deflection element is disposed beneath the hose drum. This permits a compact construction of the high-pressure cleaning device, it being possible for the space required for the hose drum and for feeding the high-pressure hose to be kept low.

Provision may be made for the hose drum to have a cylindrical winding core and side cheeks which protrude radially beyond the winding core, and, starting from the hose drum, for at least one first deflection element to be disposed at a spacing from the winding core, said spacing being greater than the diameter of the winding core. Winding and unwinding of the high-pressure hose onto and from the hose drum is simplified by providing a relatively large spacing between the winding core and the first deflection element. This is particularly true when the side cheeks are at a relatively great distance from one another. The spacing between the first deflection element and the winding core, which spacing is selected to be rather large, allows the high-pressure hose to be reliably fed to the winding core without there being a risk of the high-pressure hose being wound onto the winding core in a non-uniform manner.

It is particularly advantageous when the spacing between the first deflection element and the winding core is at least 1.5 times the diameter of the winding core.

In an advantageous configuration, the first deflection element is formed as a deflection rod, of which the length corresponds at least to the spacing of the side cheeks from one another. The deflection rod is preferably mounted in a freely rotatable manner, it being possible for the rotation axis of the deflection rod to be aligned parallel to the rotation axis of the hose drum.

In a configuration of the high-pressure cleaning device according to the invention which is of particularly compact construction, the high-pressure hose can be oriented substantially horizontally at the first deflection element. For example, the high-pressure hose can be guided from the winding core to the first deflection element in a manner oriented obliquely to the horizontal, and there be deflected into a horizontal plane. In a preferred configuration, the high-pressure hose can be deflected through at least 90° at the first deflection element.

In a preferred configuration, at least one second deflection element is disposed at a spacing from the first deflection element, said spacing corresponding at least to the diameter of the winding core. This allows the high-pressure hose to be relieved of tension between the first and the second deflection element and this, in turn, makes it easier to wind the high-pressure hose onto the hose drum.

The spacing between the first deflection element and the second deflection element is preferably at least 1.5 times the diameter of the winding core.

It is advantageous when the high-pressure hose can be oriented substantially parallel to the horizontal axis of the housing at the second deflection element. This allows the high-pressure hose to emerge, in a structurally simple manner, at the rear face of the housing, in an orientation parallel to the horizontal axis of the housing.

The second deflection element may be formed, for example, as a freely rotatable deflection roller. The rotation axis of the deflection roller is preferably aligned vertically.

The second deflection element may have a plurality of freely rotatable deflection rollers which together allow the high-pressure hose to be deflected through an angle of approximately 90°.

The following description of a preferred embodiment of the invention serves for more detailed explanation in connection with the drawings.

### BRIEF DESCRIPTION OF THE DRAWINGS

FIG. 1: shows a perspective illustration of a high-pressure cleaning device according to the invention;

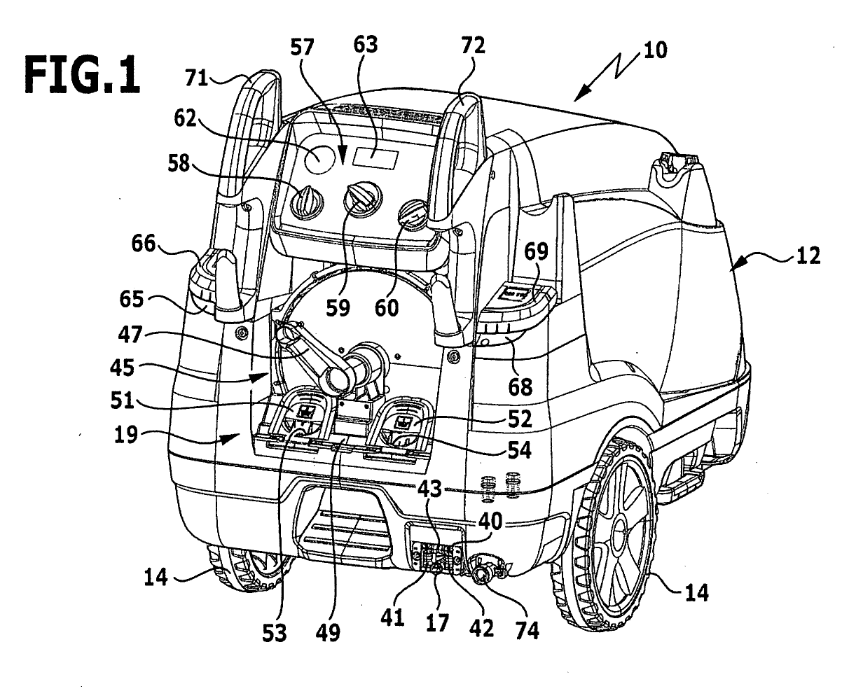

FIG. 2: shows a partially cut-away view of the high-pressure cleaning device from the rear, and

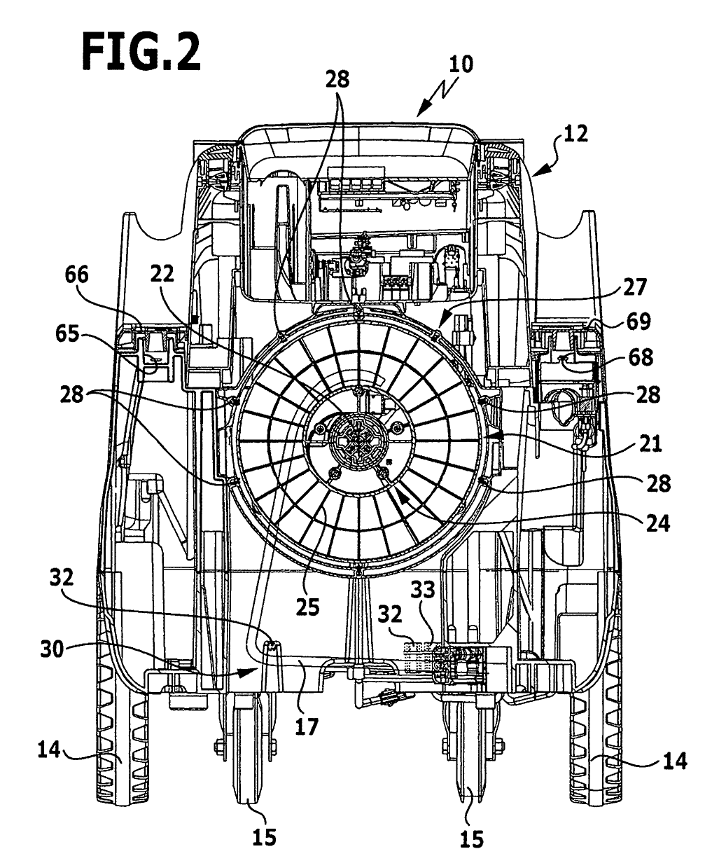

FIG. 3: shows a partially sectioned illustration of the high-pressure cleaning device in the region of the rear face of said high-pressure cleaning device.

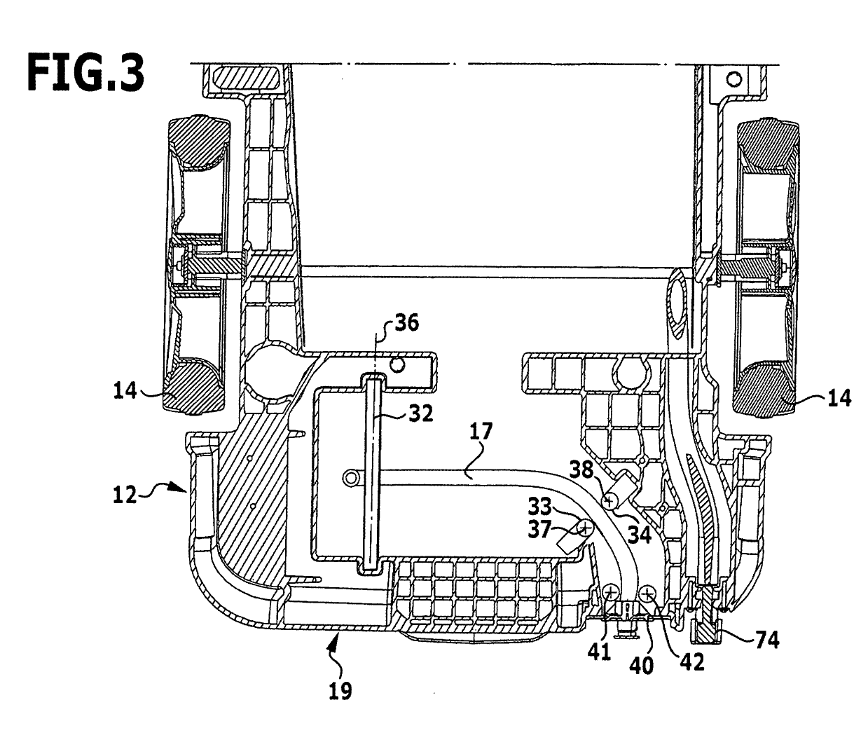

### DETAILED DESCRIPTION OF THE INVENTION

The drawing schematically illustrates a heatable high-pressure cleaning device 10 having a housing 12 which is mounted such that it can move on rear wheels 14 and front wheels 15 and accommodates, in a customary manner, a pump (not illustrated in the drawing), a drive motor which drives the pump, and also a fuel-operated heat exchanger. Pumps, drive motors and heat exchangers of this kind are known to the person skilled in the art and therefore are not illustrated in the drawing. The pump can be used to pressurize a cleaning liquid, preferably water, and the heat exchanger can be used to heat the cleaning liquid.

For delivery of the pressurized cleaning liquid, the high-pressure cleaning device 10 comprises a high-pressure hose 17 which can be wound onto a hose drum 21 that is disposed within the housing 12 in the region of the rear face 19 of said housing. The hose drum 21 is mounted such that it can rotate about a rotation axis 22 which is aligned parallel to the horizontal longitudinal axis (horizontal axis) of the housing 12.

The hose drum 21 comprises a cylindrical winding core 24 and two side cheeks which are disposed at a spacing from one another and protrude radially beyond the winding core, only one side cheek 25 of the two side cheeks being illustrated in the drawing. The two side cheeks are oriented parallel to one another and are each in the form of a lattice.

One end of the high-pressure hose 17 enters the winding core 24 and is connected to a pressure line, which is fixed to the housing, via a stationary liquid coupling, which is known per se and therefore not illustrated in detail in the drawing, in the rotation axis 22 of the hose drum 21, said pressure line being connected to the outlet of the pump. A liquid-tight connection between the pressure line and the high-pressure hose 17 is ensured by means of the liquid coupling in each position of the hose drum 21.

The hose drum 21 is surrounded by a cage 27 which is formed from a plurality of crosspieces 28 which are disposed at a spacing from one another and which are each aligned parallel to the rotation axis 22 of the hose drum 21 and are disposed in a distributed manner over the outer periphery of the side cheeks 25. The cage 27 ensures that the high-pressure hose 17 cannot form, in an uncontrolled manner, a loop which protrudes from the hose drum 21.

The high-pressure hose 17 is guided radially to the outside between two crosspieces 28 and, beneath the hose drum 21, meets a hose guide device 30 having a first deflection element in the form of a deflection rod 32 and having a second deflection element in the form of two deflection rollers 33, 34 between which the high-pressure hose 17 is guided. The deflection rod 32 can be freely rotated about a rotation axis 36 which is aligned parallel to the horizontal longitudinal axis of the housing 12, and the two deflection rollers 33, 34 can be freely rotated about vertically oriented rotation axes 37, 38. The high-pressure hose 17 is guided from the winding core 24 to the deflection rod 32 with an orientation oblique to the vertical. At the deflection rod 32, the high-pressure hose 17 undergoes a first deflection in such a way that it is then oriented substantially horizontally. In the horizontal plane which is defined by the high-pressure hose 17, said high-pressure hose then undergoes a further deflection at the deflection rollers 33, 34, so that it is then oriented parallel to the horizontal longitudinal axis of the housing 12 and can be pulled out of the housing 12 via a housing opening 40 which is located on the rear face 19 of the housing 12. Further deflection rollers 41, 42, 43 which are each mounted in a freely rotatable manner are disposed at the housing opening 40. The rotation axes of the deflection rollers 41 and 42 are aligned vertically and the rotation axis of the deflection roller 43 is aligned horizontally. The high-pressure hose 17 is guided between the two deflection rollers 41 and 42, and the deflection roller 43 is disposed at the housing opening 40 above the high-pressure hose 17 and bridges the spacing between the deflection rollers 41 and 42.

The hose drum 21 is rotated about the rotation axis 22 in order to wind up the high-pressure hose 17. To this end, a hand crank 47 is mounted such that it can rotate about a rotation axis which is aligned to coincide with the rotation axis 22 of the hose drum 21 in a recess 45 in the rear face of the housing 12. Two filling openings 53 and 54 which can each be closed by a respective cover 51 or 52 are disposed on a base wall 49 of the recess 45. Two chemical tanks which are disposed within the housing 12 can be filled, via the two filling openings 43 and 44, with cleaning chemicals, which can be admixed with the pressurized liquid.

An operator control panel 57 having a plurality of operator control elements 58, 59, 60 is disposed on the housing 12 above the recess 45. All the units of the high-pressure cleaning device 10, that is to say in particular the pump, drive motor and heat exchanger of said high-pressure cleaning device, can be controlled by means of the operator control elements 58, 59, 60. The operator control panel 57 also comprises indicator elements 62, 63 from which the user can read the operating values of the high-pressure cleaning device 10, for example the temperature of the heated liquid and also the pressure of said liquid.

The housing 12 has, in addition to the abovementioned chemical tanks, a fuel tank for storing fuel for the heat exchanger. The fuel tank can be filled via a filling opening 65 which is disposed laterally next to the recess 45 and is closed by a cover 66.

A further filling opening 68 which is closed by a cover 69 is disposed on that side of the recess 45 which is remote from the filling opening 65 for the fuel tank, and a storage tank for a limescale-removing solution, which storage tank is likewise disposed in the housing 12, can be filled via said further filling opening.

Handles 71, 72 for moving the high-pressure cleaning device 10 are disposed laterally next to the operator control panel 57.

The high-pressure cleaning device 10 can be operated in a simple manner from the rear face 19 since all the operator control elements of the high-pressure cleaning device 10 and all the filling openings 53, 54, 65, 68 for storage tanks and also the hand crank 47 for winding up the high-pressure hose 17 are disposed on the rear face 19 of the housing 12. The high-pressure hose 17 can also be drawn off at the rear face 19 of the housing 12. A connection 74 for connecting a low-pressure hose is also disposed on the rear face 19. Liquid can be supplied to the high-pressure cleaning device 10 via the low-pressure hose, said liquid then being pressurized by the pump. The connection 74 is disposed immediately next to the housing opening 40 through which the high-pressure hose 17 is guided.

1. High-pressure cleaning device having a housing in which a pump and a drive motor are disposed, it being possible for pressurized liquid to be delivered by the pump via a high-pressure hose and it being possible for the high-pressure hose to be wound onto a hose drum which is mounted within the housing such that it can rotate about a rotation axis, and for said high-pressure hose to be routed out of the housing at the rear, wherein the rotation axis of the hose drum is aligned parallel to the horizontal axis of the housing.

2. High-pressure cleaning device according to claim 1, wherein a hand crank is rotatably mounted on the rear face of the housing for winding the high-pressure hose onto the hose drum.

3. High-pressure cleaning device according to claim 2, wherein the hand crank is disposed in a recess in the rear face of the housing.

4. High-pressure cleaning device according to claim 3, wherein operator control elements of the high-pressure cleaning device are disposed above the recess.

5. High-pressure cleaning device according to claim 3, wherein at least one filling opening for filling a storage tank which is disposed in the housing is positioned in the recess.

6. High-pressure cleaning device according to claim 3, wherein at least one filling opening for filling a storage tank which is disposed in the housing is positioned next to the recess.

7. High-pressure cleaning device according to claim 3, wherein the recess is disposed between two filling openings, it being possible for in each case a storage tank which is disposed in the housing to be filled via said filling openings.

8. High-pressure cleaning device according to claim 1, wherein all the operator control elements of the high-pressure cleaning device are disposed on the rear face of the housing.

9. High-pressure cleaning device according to claim 1, wherein a hose guide device is disposed in the housing for guiding the high-pressure hose from the hose drum to an opening in the rear face of the housing.

10. High-pressure cleaning device according to claim 9, wherein the hose guide device has a plurality of deflection elements which are disposed at a spacing from one another.

11. High-pressure cleaning device according to claim 10, wherein at least one deflection element is disposed beneath the hose drum.

12. High-pressure cleaning device according to claim 10, wherein the hose drum has a cylindrical winding core and side cheeks which protrude radially beyond the winding core, and wherein, starting from the hose drum, at least one first deflection element is disposed at a spacing from the winding core, said spacing being greater than the diameter of the winding core.

13. High-pressure cleaning device according to claim 12, wherein the spacing between the first deflection element and the winding core is at least 1.5 times the diameter of the winding core.

14. High-pressure cleaning device according to claim 12, wherein the first deflection element is formed as a deflection rod, of which the length is at least equal to the spacing between the two side cheeks.

15. High-pressure cleaning device according to claim 12, wherein the high-pressure hose can be oriented substantially horizontally at the first deflection element.

16. High-pressure cleaning device according to claim 12, wherein at least one second deflection element is disposed at a spacing from the first deflection element, said spacing corresponding at least to the diameter of the winding core.

17. High-pressure cleaning device according to claim 16, wherein the spacing between the first deflection element and the second deflection element is at least 1.5 times the diameter of the winding core.

18. High-pressure cleaning device according to claim 16, wherein the high-pressure hose can be oriented substantially parallel to the longitudinal axis of the housing at the second deflection element.

19. High-pressure cleaning device according to claim 16, wherein the second deflection element is formed as a freely rotatable deflection roller.
